(19) United States
(12) Patent Application Publication
(10) Pub. No.: US 2021/0360545 A1
(43) Pub. Date: Nov. 18, 2021

(54) METHODS AND APPARATUSES FOR SYNCHRONIZATION SIGNAL (SS) RASTERS AND OVERLAPPING BANDS

(71) Applicant: Telefonaktiebolaget LM Ericsson (publ), Stockholm (SE)

(72) Inventor: Johan SKÖLD, Solna (SE)

(21) Appl. No.: 16/344,224

(22) PCT Filed: Nov. 16, 2018
(86) PCT No.: PCT/EP2018/081596

§ 371 Date: Apr. 23, 2019

Related U.S. Application Data
(60) Provisional application No. 62/587,607, filed on Nov. 17, 2017.

(51) Int. Cl. H04W 56/00; H04L 27/26; H04J 11/00

(52) U.S. Cl. CPC H04W 56/001; H04J 11/0076; H04J 11/0073; H04L 27/26025

(57) ABSTRACT

Apparatuses and methods are disclosed for synchronization signal spacing and overlapping frequency bands. In one embodiment, a method for a network node includes generating at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band. In another embodiment, a method for a wireless device includes receiving at least one synchronization signal associated with a first frequency band. The at least one synchronization signal is associated with a synchronization raster spacing that is the same as a synchronization raster spacing associated with a second frequency hand. The second frequency band is at least partially overlapping at least the first frequency band.

### TECHNICAL FIELD

Wireless communication and in particular, to synchronization signal spacing and overlapping frequency bands.

### BACKGROUND

When a mobile device, such as, for example, a wireless device (WD), user equipment (UE) is to first connect to a network, it may not have knowledge of the frequencies of the downlink radio frequency (RF) carrier(s) (also called RF channels) transmitted by the network, such as, for example, a network node. The WD performs an initial cell search by scanning the possible RF carrier positions and tries to identify and synchronize to available downlink carriers. Once connected to a network, a cell search must be performed continuously by the wireless device in order to provide mobility, since the wireless device may need to find and identify adjacent candidate cells for handover.

The more possible carrier positions, the longer time initial cell search generally takes. For this reason, there should be a limited number of carrier positions in the carrier raster for a wireless device to perform a cell search on. The possible positions of a carrier are given by a carrier raster, also sometimes referred to as a carrier grid. As an example, possible frequency-domain positions of carriers, such as, for example, Long-Term Evolution (LTE) carriers are given by a 100 kHz carrier raster, see for example FIG. 1, that also shows two examples of carrier positions. Note that, for drawing reasons, the bandwidths of the carriers are unrealistically small in the figures, which are provided merely as an example. In typical cases, the bandwidth of a carrier may be several megahertz (MHz). As used herein, the terms “carrier” and “carrier frequency” are used interchangeably and are intended to indicate a carrier frequency.

To find carriers, a wireless device may search for synchronization signals transmitted by cells, such as a network node. As an example, in LTE, each cell transmits two synchronization signals, a Primary Synchronization Signal (PSS) and a Secondary Synchronization Signal (SSS). Jointly, the PSS/SS enables a device to:

Find a cell;

Determine the timing of the found cell; and/or

Determine the physical identity of the found cell.

In LTE, the PSS and SSS are located at the center of the carrier. Thus, without any a priori knowledge regarding the frequency position of potential carriers, except that they lie on the carrier raster, a wireless device may be required to search for PSS/SSS at every position of the carrier raster.

The same basic structure with a PSS/SSS enabling devices to: 1) find a cell, 2) determine the timing the found cell, and 3) determine the physical cell identity of the found cell, is used also for the new 5G radio interface, also referred to as “New Radio” (NR). In NR, the PSS/SS together with a specific broadcast channel, the physical broadcast channel (PBCH), transmitted together with the PSS/SSS, is jointly referred to as an “SS Block”.

To reduce the time for carrier search when there is no a priori knowledge of the frequency location of carriers, the concept of a sparse raster for SS Block transmission has been introduced for NR. Sparse raster for SS Block implies that the set of possible or candidate frequency-domain positions of SS Blocks (the “SS Block raster,” sometimes called “sync raster”) is significantly more sparse compared to the possible frequency positions of carriers (the “carrier raster”, sometimes called “RF channel raster” or “channel raster”). FIG. 2 illustrates an example case where the points (e.g., points a, b, c, d) on the SS Block raster are separated by ΔFSS raster=1 MHz, i.e. the SS Block raster is ten times more sparse compared to the carrier raster. As used herein, the capital letter “F” indicates frequency and “BW” indicates bandwidth.

How sparse a raster can be, i.e. how large ΔF_{SS,Raster} can be, is determined by the total bandwidth of the Carrier Resource Blocks BW_{Carrier}, the width of the SS block (which is determined by the PBCH) BW_{PBCH}, and the carrier raster spacing ΔF_{CH,Raster}, observing that the PBCH (and thus the SS block) can be anywhere on the carrier, but has to be totally within the carrier.

In the example in FIG. 3, two adjacent carrier positions 1 and 2 are shown, where Position 1 has the SS block at the far left of the carrier centered at F_{SS,1}, which implies that for the adjacent Position 2, the SS block cannot remain in position F_{SS,1} and still be within the carrier. The next position of the SS block within the carrier which also has the largest (most sparse) spacing possible is F_{SS,2} at the far right of the carrier in position 2.

Position 1 is thus the highest (leftmost) position of BW_{Carrier} on the RF channel raster where the SS block can be related to the sync channel position F_{SS,1} and Position 2 will be the lowest (rightmost) position of BW_{Carrier} the RF channel raster where the SS block can be related to the sync channel position F_{SS,2}. Because Position 1 and 2 are adjacent on the channel raster, they are spaced ΔF_{SS,Raster}. The two SS block positions are adjacent on the SS raster and are thus spaced ΔF_{SS,Raster}.

From FIG. 3 it is derived that the SS raster spacing ΔF_{SS,Raster} will be limited by the following equation:

ΔF_{SS,Raster}≤BW_{Carrier}−BW_{PBCH}+ΔF_{CH,Raster} (1)

Equation (1) can he used in the following to derive the possible sync channel rasters in different bands. The number of Carrier Resource Blocks, or BWCarrier, depends on the subcarrier spacing (SCS) of the SS block, the size of the NR resource blocks and the number of resource blocks that fit on the carrier, also called the Spectrum Utilizatkm.

The following example is based on the present RF parameters for NR to be used in a range of frequency bands where LTE is currently deployed. The principle and the related problems and possible solutions would, however, apply also for other similar or different parameters or combinations in the same or other bands.

NR can operate with RF carriers having different channel bandwidths and thus different widths of the carrier resource blocks. There are 12 subcarriers in a resource block and 52 resource blocks fit on a 10 MHz carrier (the number of resource blocks on a carrier indicated herein as “N_{RB,Carrier}”). The width of the carrier resource blocks on the 10 MHz carrier will be (N_{RB,Carrier}) * (Number of subcarriers in a resource block) * (SCS for SS block)=52*12*15 kHz=9.36 MHz.

There can be carriers of different channel BW and thus different BW_{Carrier} in the same band. Since it must always be possible to have at least one SS block within each carrier in the band, it is the smallest bandwidth possible in the band that is used in equation (1) to derive the maximum possible ΔF_{SS,Raster}. This is done for three different minimum bandwidths (10, 15 and 20 MHz) in Table 1.

TABLE 1
Derived maximum sync raster spacing
based on example parameters

| | | | Width | |
|---|---|---|---|---|
| | | | of Carrier | |
| Minimum | SCS | | resource blocks | Max |
| BW | for SS | | BW_{Carrier} | ΔF_{SC, Raster} |
| [MHz] | [kHz] | N_{RB, Carrier} | [kHz] | [MHz] |
| 10 | 15 | 52 | 9,360 | 5,775 |
| 15 | 15 | 79 | 14,220 | 10,635 |
| 20 | 15 | 106 | 19,080 | 15,495 |

In a given frequency range, the chosen sync raster spacing will generate a set of sync raster entries. These are shown in FIG. 4 for a frequency range starting at X MHz and spanning 20 MHz, using the maximum possible SS raster spacing according to Table 1 above. One example carrier location per case is also shown in the figure.

There are problems with existing solutions. For example, while the sync raster spacing values in Table 1 I are possible, they may not be the most efficient choice. It is often the case that multiple operating bands are defined over the same frequency range, either fully or partly overlapping. The reason for the multiple band definitions is that these may have different fundamental regulatory and/or operational requirements, since they are used in different countries or regions and will be deployed by operators that have different requirements.

WDs are designed to operate globally and often support a large number of bands deployed by different operators in different countries and regions. This means that a WD at initial cell access may be searching for an SS block in a frequency range that has multiple potential band definitions.

Because the different bands may have different regulatory and operational requirements, they can also be defined with different minimum channel BW and the different hands would then have different SS rasters, As an illustration, in the FIG. 4 example, assume that there are overlapping bands defined where one band has 10 MHz, one has 15 MHz and one has 20 MHz minimum channel BW. Each band would have its own SS raster according to for example, FIG. 4, with a total of 8 raster entries in the 20 MHz range (each of the 8 raster entries depicted in FIG. 4 indicated schematically by an upward arrow). This would increase the initial access time, since the UE needs to search over more raster entries.

Another aspect of overlapping bands in the same frequency range is that the WD must at some point identify which operating band it is actually accessing, since a WD only has hardware support for operating in a specific set of bands. The set of bands a WD is able to operate in is called the WD or UE capability and is a fundamental set of parameters defining the WD.

### SUMMARY

Some embodiments advantageously provide methods and apparatuses for synchronization signal spacing and overlapping frequency bands that may advantageously, e.g., reduce initial cell search time in overlapping bands. Some embodiments include generating at least one synchronization signal of a set of synchronization signals. The set of synchronization signals are separated by a predetermined frequency spacing. The predetermined frequency spacing is configured to have a common multiple with a frequency spacing of at least one at least partially overlapping frequency band. Some embodiments advantageously provide methods, systems, and apparatuses for receiving at least one synchronization signal of a set of synchronization signals, and determining that the at least one synchronization signal is associated with the set of synchronization signals being separated by a predetermined frequency spacing. The predetermined frequency spacing is configured to have a common multiple with a frequency spacing of at least one at least partially overlapping frequency band.

According to one aspect of the present disclosure, a network node configured to communicate with a wireless device, WD, is provided. The network node includes a radio interface and processing circuitry. The processing circuitry is configured to cause the radio interface to generate at least one synchronization signal associated with a first frequency band. The at least one synchronization signal is associated with a synchronization raster spacing that is the same as a synthronization raster spacing associated with a second frequency band. The second frequency band is at least partially overlapping at least the first frequency band.

In some embodiments of this aspect, the first frequency band is different from the second frequency band. In some embodiments of this aspect, in a frequency range where the first frequency band and the second frequency band overlap one another, raster entries for each of the first frequency band and the second frequency band are the same. In some embodiments of this aspect, if a channel bandwidth and a subcarrier spacing corresponding to the second frequency band are the same as a channel bandwidth and a subcarrier spacing corresponding to the first frequency band, the at least one synchronization signal is based on the synchronization raster spacing that is the same as the synchronization raster spacing associated with the second frequency band. In some embodiments of this aspect, the at least one synchronization signal includes at least one synchronization signal block, SS block. In some embodiments of this aspect, the at least one synchronization signal includes at least one of a primary synchronization signal, PSS, and a secondary synchronization signal, SSS. In some embodiments of this aspect, the processing circuitry is further configured to cause the radio interface to communicate a parameter in a system information message. The parameter indicates at least one possible frequency band associated with a raster entry of the generated at least one synchronization signal.

According to another aspect of the present disclosure, a method for a network node configured to communicate with a wireless device, WD, is provided. The method includes generating at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band.

In some embodiments of this aspect, the first frequency band is different from the second frequency band. In some embodiments of this aspect, in a frequency range where the first frequency band and the second frequency band overlap one another, raster entries for each of the first frequency band and the second frequency band are the same. In sonic embodiments of this aspect, if a channel bandwidth and a subcarrier spacing corresponding to the second frequency band are the same as a channel bandwidth and a subcarrier spacing corresponding to the first frequency band, the at least one synchronization signal is based on the synchronization raster spacing that is the same as the synchronization raster spacing associated with the second frequency band. In some embodiments of this aspect, the at least one synchronization signal includes at least one synchronization signal block, SS block. In some embodiments of this aspect, the at least one synchronization signal includes at least one of a primary synchronization signal, PSS, and a secondary synchronization signal, SSS. In some embodiments of this aspect, the method further includes communicating a parameter in a system information message. The parameter indicates at least one possible frequency band associated with a raster entry of the generated at least one synchronization signal.

According to yet another aspect of the present disclosure, a wireless device, WD, configured to communicate with a network node is provided. The WD includes a radio interface and processing circuitry. The processing circuitry is configured to receive at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band.

In some embodiments of this aspect, the first frequency band is different from the second frequency band. In some embodiments of this aspect, in a frequency range where the first frequency band and the second frequency band overlap one another, raster entries for each of the first frequency band and the second frequency band are the same. In some embodiments of this aspect, if a channel bandwidth and a subcarrier spacing corresponding to the second frequency band are the same as a channel bandwidth and a subcarrier spacing corresponding to the first frequency band, the at least one synchronization signal is based on the synchronization raster spacing that is the same as the synchronization raster spacing associated with the second frequency band. In some embodiments of this aspect, the at least one synchronization signal includes at least one synchronization signal block, SS block. In some embodiments of this aspect, the at least one synchronization signal includes at least one of a primary synchronization signal, PSS, and a secondary synchronization signal, SSS. In some embodiments of this aspect, the radio interface is configured to receive a parameter in a system information message. The parameter indicates at least one possible frequency band associated with a raster entry of the received at least one synchronization signal. In some embodiments of this aspect, the processing circuitry is further configured to perform a cell search and identify the first frequency band based at least in part on the received at least one synchronization signal.

According to yet another aspect of the present disclosure, a method for a wireless device, WD, configured to communicate with a network node is provided. The method includes receiving at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band.

In some embodiments of this aspect, the first frequency band is different from the second frequency band. In some embodiments of this aspect, in a frequency range where the first frequency band and the second frequency band overlap one another, raster entries for each of the first frequency band and the second frequency band are the same. In sonic embodiments of this aspect, if a channel bandwidth and a subcarrier spacing corresponding to the second frequency band are the same as a channel bandwidth and a subcarrier spacing corresponding to the first frequency band, the at least one synchronization signal is based on the synchronization raster spacing that is the same as the synchronization raster spacing associated with the second frequency band. In some embodiments of this aspect, the at least one synchronization signal includes at least one synchronization signal block, SS block. In some embodiments of this aspect, the at least one synchronization signal includes at least one of a primary synchronization signal, PSS, and a secondary synchronization signal, SSS. In some embodiments of this aspect, the method further includes receiving a parameter in a system information message. The parameter indicates at least one possible frequency band associated with a raster entry of the received at least one synchronization signal. In some embodiments of this aspect, the method further includes performing a cell search and identifying the first frequency band based at least in part on the received at least one synchronization signal.

According to yet another aspect of the present disclosure, a network node configured to communicate with a wireless device, WD, is provided. The network node includes a radio interface and processing circuitry. The processing circuitry is configured to cause the radio interface to generate at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band.

In some embodiments of this aspect, the first frequency band is different from the second frequency band. In some embodiments of this aspect, if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band. In some embodiments of this aspect, the at least one synchronization signal includes at least one synchronization signal block, SS block. In some embodiments of this aspect, the processing circuitry is further configured to cause the radio interface to communicate a parameter in a system information message. The parameter indicates at least one possible frequency band associated with a raster entry of the generated at least one synchronization signal.

According to yet another aspect of the present disclosure, a method for a network node configured to communicate with a wireless device, WD, is provided. The method includes generating at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band.

In some embodiments of this aspect, the first frequency band is different from the second frequency band. In some embodiments of this aspect, if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band, In some embodiments of this aspect, the at least one synchronization signal includes at least one synchronization signal block, SS block. In some embodiments of this aspect, the method further includes communicating a parameter in a system information message. The parameter indicates at least one possible frequency band associated with a raster entry of the generated at least one synchronization signal.

According to another aspect of the present disclosure, a wireless device, WD, configured to communicate with a network node is provided. The WD includes a radio interface and processing circuitry. The processing circuitry is configured to receive at least one synchronization signal associated with a first frequency band. The at least one synchronization signal is associated with a synchronization raster spacing that is an integer multiple of a synchronization raster spacing associated with a second frequency band, the second frequency band at least partially overlapping at least the first frequency band.

In some embodiments of this aspect, the first frequency band is different from the second frequency band. In some embodiments of this aspect, if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band. In some embodiments of this aspect, the at least one synchronization signal includes at least one synchronization signal block, SS block. In some embodiments of this aspect, the radio interface is configured to receive a parameter in a system information message. The parameter indicates at least one possible frequency band associated with a raster entry of the received at least one synchronization signal. In some embodiments of this aspect, the processing circuitry is further configured to perform a cell search and identify the first frequency band based at least in part on the received at least one synchronization signal.

According to another aspect of the present disclosure, a method for a wireless device, WD, configured to communicate with a network node is provided. The method includes receiving at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band.

In some embodiments of this aspect, the first frequency band is different from the second frequency band. In some embodiments of this aspect, if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band. In some embodiments of this aspect, the at least one synchronization signal includes at least one synchronization signal block, SS block. In some embodiments of this aspect, the method further includes receiving a parameter in a system information message. The parameter indicates at least one possible frequency band associated with a raster entry of the received at least one synchronization signal. In some embodiments of this aspect, the method further includes performing a cell search and identifying the first frequency band based at least in part on the received at least one synchronization signal.

According to yet another aspect of the present disclosure, a system is provided that includes a network node configured to perform the method(s) of any of the embodiments for the network node; and a wireless device configured to perform the method(s) of any of the embodiments for the wireless device.

According to another aspect of the present disclosure, a method for a system comprising a network node and a wireless device is provided. The method includes the network node generating at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band. The wireless device receives the at least one generated synchronization signal. In some embodiments of this aspect, the method may further include any of the methods performed by the network node and/or the wireless device.

According to another aspect of the present disclosure, a method system comprising a network node and a wireless device is provided. The method includes the network node generating at least one synchronization signal associated with a first frequency hand. The at least one synchronization signal is associated with a synchronization raster spacing that is an integer multiple of a synchronization raster spacing associated with a second frequency band. The second frequency band is at least partially overlapping at least the first frequency band. The wireless device receives the at least one generated synchronization signal. In some embodiments of this aspect, the method may further include any of the methods performed by the network node and/or the wireless device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an exemplary LTE carrier raster with two examples of carrier positions according to some embodiment of the present disclosure;

FIG. 2 illustrates an exemplary relation between Carrier raster and SS block raster according to some embodiments of the present disclosure;

FIG. 3 illustrates exemplary possible shifts for the PBCH as the transmitted carrier is shifted on the RF carrier;

FIG. 4 illustrates example sync raster entries for 10, 15 and 20 MHz minimum BW when selecting the maximum possible ΔF_{SC,Raster};

FIG. 5 is a schematic diagram of an exemplary network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a block diagram of an alternative ethbodiment of a host computer according to some embodiments of the present disclosure;

FIG. 8 is a block diagram of an alternative embodiment of a network node according to some embodiments of the present disclosure;

FIG. 9 is a block diagram of an alternative embodiment of a wireless device according to some embodiments of the present disclosure;

FIG. 10 is a flowchart illustrating exemplary methods implemented in a communication system including a host computer, a network node and a wireless device for executing a client application at a wireless device according to some embodiments of the present disclosure;

FIG. 11 is a flowchart illustrating exemplary methods implemented in a communication system including a host computer, a network node and a wireless device for receiving user data at a wireless device according to some embodiments of the present disclosure;

FIG. 12 is a flowchart illustrating exemplary methods implemented in a communication system including a host computer, a network node and a wireless device for receiving user data from the wireless device at a host computer according to some embodiments of the present disclosure;

FIG. 13 is a flowchart illustrating exemplary methods implemented in a communication system including a host computer, a network node and a wireless device for receiving user data at a host computer according to some embodiments of the present disclosure;

FIG. 14 is a flowchart of an exemplary process in a network node for generating at least one synchronization signal according to some embodiments of the present disclosure;

FIG. 15 is a flowchart of yet another exemplary process in a network node for generating at least one synchronization signal according to other embodiments of the present disclosure;

FIG. 16 is a flowchart of yet another exemplary process in a network node for generating at least one synchronization signal according to other embodiments of the present disclosure;

FIG. 17 is a flowchart of an exemplary process in a wireless device for receiving at least one synchronization signal during a cell search according to some embodiments of the present disclosure;

FIG. 18 is a flowchart of yet another exemplary process in a wireless device for receiving at least one synchronization signal during a cell search according to other embodiments of the present disclosure;

FIG. 19 is a flowchart of yet another exemplary process in a wireless device for receiving at least one synchronization signal during a cell search according to other embodiments of the present disclosure; and

FIG. 20 illustrates example sync raster entries for 10, 15 and 20 MHz minimum BW, selected as integer multiples of the 10 MHz case.

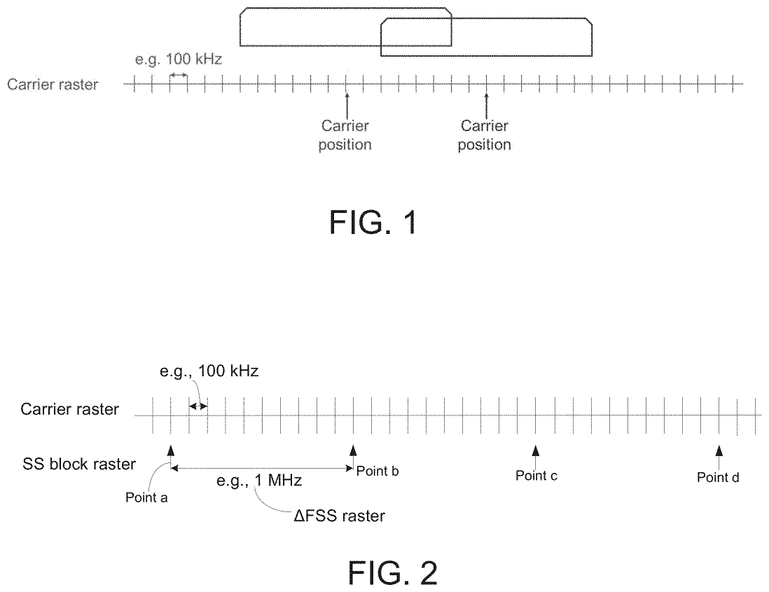

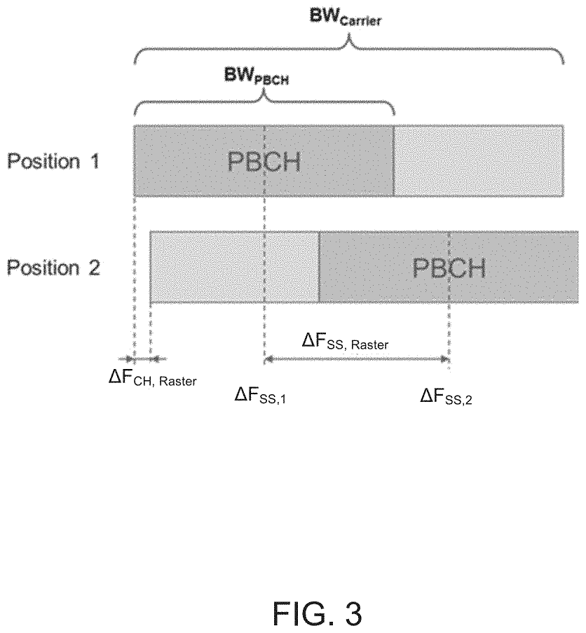

### DETAILED DESCRIPTION

Before describing in detail exemplary embodiments, it is noted that the embodiments reside primarily in combinations of apparatus components and processing steps related to synchronization signal spacing and overlapping frequency bands. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME). USB dongles, Customer Premises Equipment (CPE), an Internet of Things (IoT) device, or a Narrowband IoT (NB-IOT) device etc.

Also in sonic embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE, may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide for spacing synchronization signals so that raster entries overlap as much as possible in overlapping bands in order to reduce initial cell search times for a wireless device. In addition, some embodiments provide for identifying one band of a set of overlapping bands as an operating band of a network node using raster position information. Some embodiments further provide for using raster position information to reduce the number of bits used for band information in a system information message. Such embodiments may decrease cell search times and improve resource efficiency.

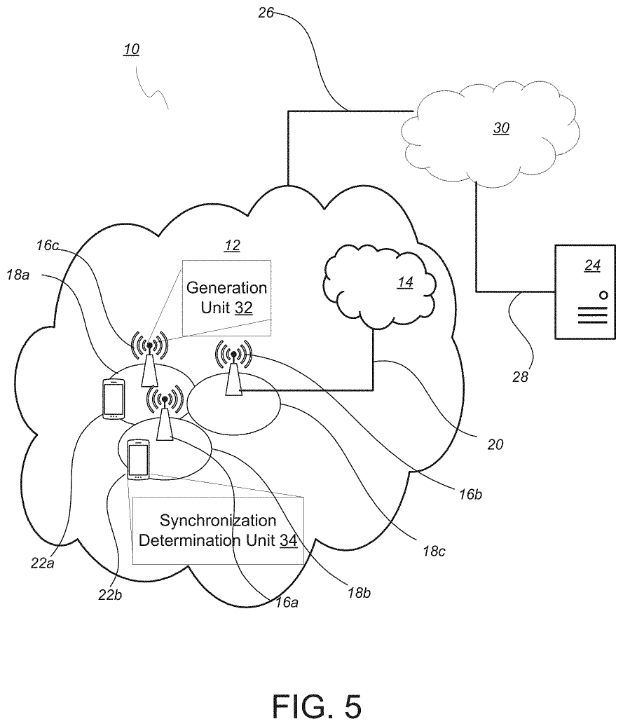

Returning to the drawing figures, in which like elements are referred to by like reference designators, there is shown in FIG. 5 a schematic diagram of a communication system, according to an embodiment, including a communication system 10, such as a 3GPP-type cellular network, which includes an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications, For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a generation unit 32 which is configured to generate at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency hand. In another embodiment, the generation unit 32 may he configured to generate at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band. In yet another embodiment, the generation unit 32 may be configured to generate at least one synchronization signal of a set of synchronization signals. The set of synchronization signals being separated by a predetermined frequency spacing. The predetermined frequency spacing is configured to have a common multiple with a frequency spacing of at least one at least partially overlapping frequency band. In yet another embodiment, the generation unit 32 may be configured to generate at least one synchronization signal associated with a first frequency band. The at least one synchronization signal is associated with a synchronization raster spacing that is a common integer multiple of a synchronization raster spacing associated with a second frequency band. The second frequency band is at least partially overlapping at least the first frequency band

A wireless device 22 is configured to include a synchronization determination unit 34 which is configured to receive at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band. In another embodiment, the synchronization determination unit 34 may be configured to receive at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band. In yet another embodiment, the synchronization determination unit 34 may be configured to determine that the at least one received synchronization signal is associated with the set of synchronization signals. The set of synchronization signals may be separated by a predetermined frequency spacing. The predetermined frequency spacing is configured to have a common multiple with a frequency spacing of at least one at least partially overlapping frequency band. In yet another embodiment, the synchronization determination unit 34 may be configured to receive at least one synchronization signal associated with a first frequency band. The at least one synchronization signal is associated with a synchronization raster spacing that is a common integer multiple of a synchronization raster spacing associated with a second frequency band The second frequency band is at least partially overlapping at least the first frequency band.

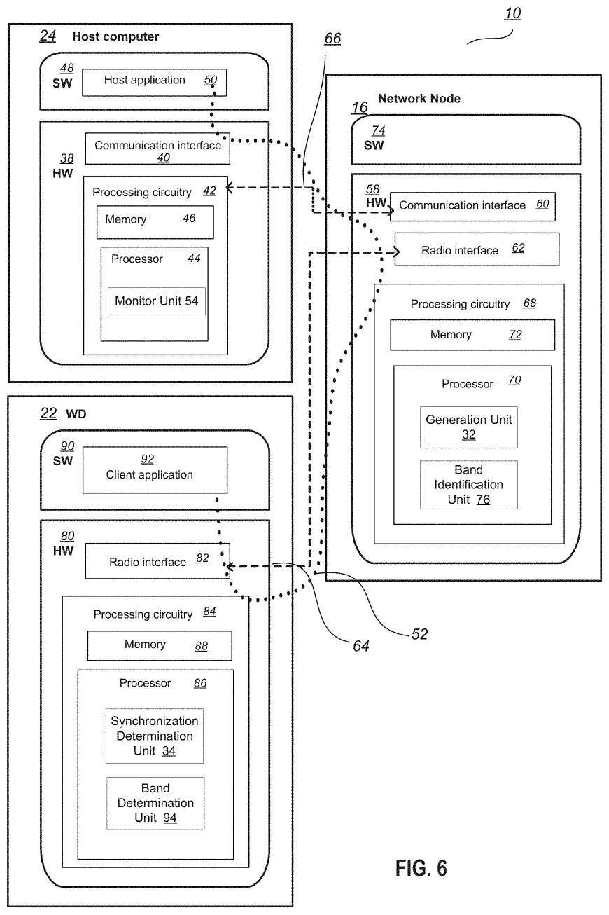

Example implementations, in accordance with an embodiment, of the WD 22, network node 16 and host computer 24 discussed in the preceding paragraphs will now be described with reference to FIG. 6, in a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to a traditional processor and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for perforating host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be configured to provide a service to a remote user, such as a WD 22 connecting via an OTT connection 52 terminating at the WD 22 and the host computer 24. In providing the service to the remote user, the host application 50 may provide user data which is transmitted using the OTT connection 52. In one embodiment, the host computer 24 may be configured for providing control and functionality to a service provider and may be operated by the service provider or on behalf of the service provider. The processing circuitry 42 of the host computer 24 may include a monitor unit 54 configured to enable the service provider to monitor synchronization signals from the network node 16 and or the wireless device 22.

The communication system 10 further includes a network node 16 provided in a communication system 10 and comprising hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to a traditional processor and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include generation unit 32. The generation unit 32 may be configured to cause the radio interface 62 to generate at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band.

In some embodiments, the first frequency band is different from the second frequency band. In some embodiments, in a frequency range where the first frequency band and the second frequency band overlap one another, raster entries for each of the first frequency band and the second frequency band are the same. In some embodiments, if a channel bandwidth and a subcarrier spacing corresponding to the second frequency band are the same as a channel bandwidth and a subcarrier spacing corresponding to the first frequency band, the at least one synchronization signal is based on the synchronization raster spacing that is the same as the synchronization raster spacing associated with the second frequency band. In some embodiments, the at least one synchronization signal includes at least one synchronization signal block, SS block. In some embodiments, the at least one synchronization signal includes at least one of a primary synchronization signal, PSS, and a secondary synchronization signal SSS. In some embodiments, the processing circuitry 68 is further configured to cause the radio interface 62 to communicate a parameter in a system information message. The parameter indicates at least one possible frequency band associated with a raster entry of the generated at least one synchronization signal.

According to another embodiment, network node 16 may include generation unit 32 configured to cause the radio interface 62 to generate at least one synchronization signal associated with a first frequency band, the at least one synchronization signal being associated with a synchronization raster spacing that is an integer multiple of a synchronization raster spacing associated with a second frequency band, the second frequency band at least partially overlapping at least the first frequency band.

In some embodiments, the first frequency band is different from the second frequency band, in some embodiments, if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band. In some embodiments, the at least one synchronization signal includes at least one synchronization signal block. SS block. In some embodiments, the processing circuitry 68 is further configured to cause the radio interface 62 to communicate a parameter in a system information message. The parameter indicates at least one possible frequency band associated with a raster entry of the generated at least one synchronization signal.

In an alternative embodiment, the generation unit 32 may be configured to generate at least one synchronization signal of a set of synchronization signals. The set of synchronization signals are separated by a predetermined frequency spacing. The predetermined frequency spacing is configured to have a common multiple with a frequency spacing of at least one at least partially overlapping, frequency band. The processing circuitry 68 may also include band identification unit 76 configured to cause the radio interface 62 to send frequency band information in a system information message. The frequency band information indicates the at least one frequency band of the network node 16 associated with the predetermined frequency spacing.

In yet another embodiment, the generation unit 32 and/or the processing circuitry 68 may be configured to generate at least one synchronization signal associated with a first frequency band. The at least one synchronization signal is associated with a synchronization raster spacing that is a common integer multiple of a synchronization raster spacing associated with a second frequency band. The second frequency hand is at least partially overlapping at least the first frequency band.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to a traditional processor and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database) accessible by the WD 22. The software 90 may be executable by the processing circuitry 84. The software 90 may include a client application 92. The client application 92 may be configured to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a synchronization determination unit 34. The synchronization determination unit 34 may be configured to cause the radio interface 82 to receive at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band.

In some embodiments, the first frequency band is different from the second frequency band. In some embodiments, in a frequency range where the first frequency band and the second frequency band overlap one another, raster entries for each of the first frequency band and the second frequency band are the same. In some embodiments, if a channel bandwidth and a subcarrier spacing corresponding to the second frequency band are the same as a channel bandwidth and a subcarrier spacing corresponding to the first frequency band, the at least one synchronization signal is based on the synchronization raster spacing that is the same as the synchronization raster spacing associated with the second frequency band. In some embodiments, the at least one synchronization signal includes at least one synchronization signal block, SS block. In some embodiments, the at least one synchronization signal includes at least one of a primary synchronization signal, PSS, and a secondary synchronization signal, SSS. In some embodiments, the radio interface 82 is configured to receive a parameter in a system information message. The parameter indicates at least one possible frequency band associated with a raster entry of the received at least one synchronization signal. In some embodiments, the processing circuitry 84 is further configured to perform a cell search and identify the first frequency band based at least in part on the received at least one synchronization signal.

According to another embodiment, a wireless device, WD 22 includes synchronization determination unit 34 configured to receive, such as via radio interface 82, at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band.

In some embodiments, the first frequency band is different from the second frequency band. In some embodiments, if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band. In some embodiments, the at least one synchronization signal includes at least one synchronization signal block, SS block. In some embodiments, the radio interface 82 is configured to receive a parameter in a system information message. The parameter indicates at least one possible frequency band associated with a raster entry of the received at least one synchronization signal. In some embodiments, the processing circuitry 84 is further configured to perform a cell search and identify the first frequency band based at least in part on the received at least one synchronization signal.

In an alternative embodiment, the synchronization determination unit 34 may be configured to cause the radio interface 82 to receive, from the network node 16, at least one synchronization signal of a set of synchronization signals. The synchronization determination unit may be configured to determine that the at least one synchronization signal is associated with the set of synchronization signals being separated by a predetermined frequency spacing. The predetermined frequency spacing is configured to have a common multiple with a frequency spacing of at least one at least partially overlapping frequency band. The processing circuitry 84 may also include band determination unit 94 configured to, after identifying a position of the at least one synchronization signal, use at least one parameter associated with the predetermined frequency spacing to identify the at least one frequency band of the network node 16 for connecting to the network node 16.

In yet another embodiment, the synchronization determination unit 34 and/or the processing circuitry 84 may be configured to receive at least one synchronization signal associated with a first frequency band. The at least one synchronization signal is associated with a synchronization raster spacing that is a common integer multiple of a synchronization raster spacing associated with a second frequency band. The second frequency band is at least partially overlapping at least the first frequency band.

Some embodiments may include a system comprising the network node 16 and the WD 22 configured according to any of the techniques, methods, processes, functions and/or features described as being performed by the network node 16 and/or WD 22, respectively.

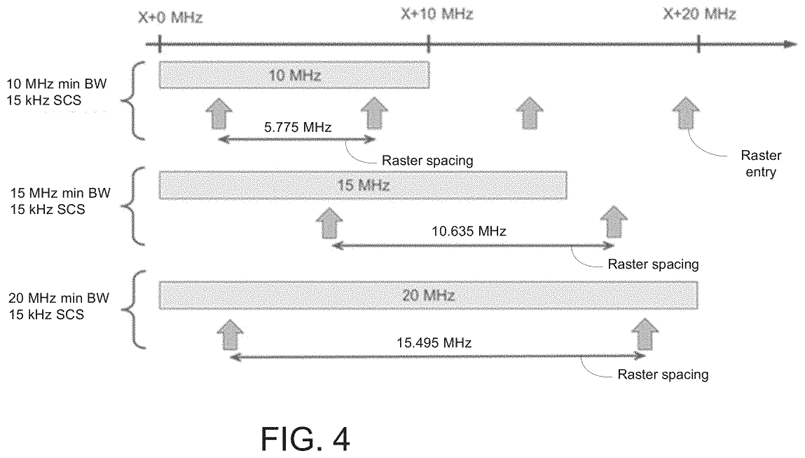

In some embodiments, the inner workings of the network node 16, WD 22, and host computer 24 may be as shown in FIG. 6 and independently, the surrounding network topology may be that of FIG. 5. Although FIGS. 4 and 5 show various “units” such as monitor unit 54, synchronization determination unit 34, band determination unit 94 and generation unit 32 and band identification unit 76 as being within a respective processor, it is contemplated that these units may be implemented such that a portion of the unit is stored in a corresponding memory within the processing circuitry. In other words, the units may be implemented in hardware or in a combination of hardware and software within the processing circuitry.

In FIG. 6. the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

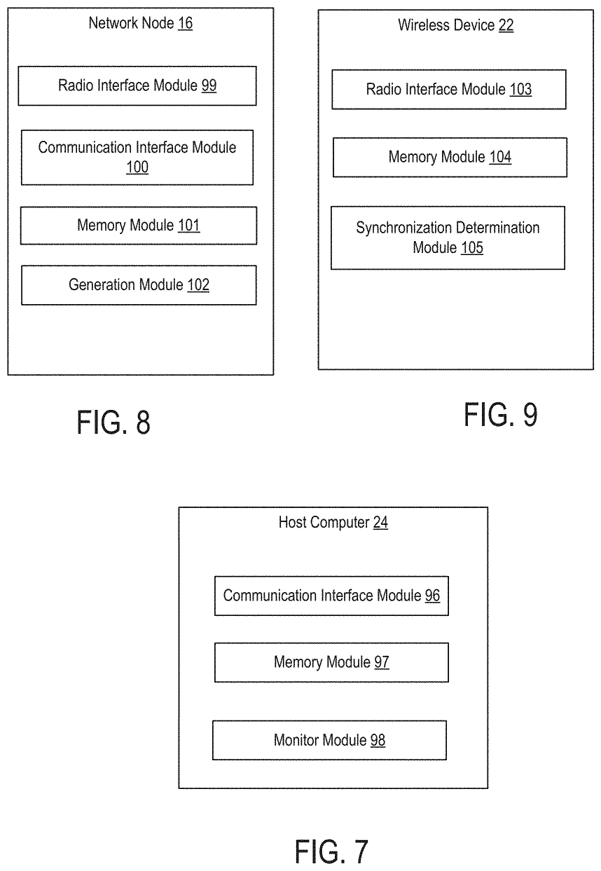

FIG. 7 is a block diagram of an alternative host computer 24, which may be implemented at least in part by software modules containing software executable by a processor to perform the functions described herein. The host computer 24 include a communication interface module 96 configured to set up and maintain a wired or wireless connection with an interface of a different communication device of the communication system 10. The memory module 97 is configured to store data, programmatic software code and/or other information described herein. Monitor module 98 is configured to enable the service provider to monitor synchronization signals from the network node 16 and or the wireless device 22.

FIG. 8 is a block diagram of an alternative network node 16, which may be implemented at least in part by software modules containing software executable by a processor to perform the functions described herein. The network node 16 includes a radio interface module 99 configured for setting up and maintaining at least a wireless connection 64 with a WD 22 located in a coverage area 18 served by the network node 16. The network node 16 also includes a communication interface module 100 configured for setting up and maintaining a wired or wireless connection with an interface of a different communication device of the communication system 10. The communication interface module 100 may also be configured to facilitate a connection 66 to the host computer 24. The memory module 101 that is configured to store data, programmatic software code and/or other information described herein. In one embodiment, the memory module 101 may be configured to store the predetermined frequency spacing configured to have a common multiple with a frequency spacing of at least one at least partially overlapping frequency band. The generation module 102 is configured to generate at least one synchronization signal of a set of synchronization signals, the set of synchronization signals being separated by the predetermined frequency spacing.

FIG. 9 is a block diagram of an alternative wireless device 22, which may be implemented at least in part by software modules containing software executable by a processor to perform the functions described herein. The WD 22 includes a radio interface module 103 configured to set up and maintain a wireless connection 64 with a network node 16 serving a coverage area 18 in which the WD 22 is currently located. The memory module 104 is configured to store data, programmatic software code and/or other information described herein. In one embodiment, the memory module 104 is configured to store the predetermined frequency spacing configured to have a common multiple with a frequency spacing of at least one at least partially overlapping frequency band. The synchronization determination module 105 is configured to receive at least one synchronization signal of a set of synchronization signals and determine that the at least one synchronization signal is associated with the set of synchronization signals being separated by the predetermined frequency spacing.

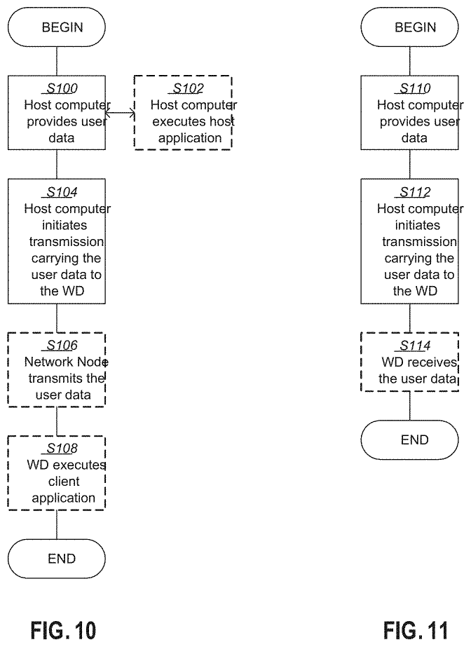

FIG. 10 is a flowchart illustrating an exempla1y method implemented in a communication system, such as, for example, the communication system of FIGS, 5 and 6, in accordance with one embodiment. The communication system may include a host computer 24, a network node 16 and a WD 22, which may be those described with reference to FIG. 6. In a first step of the method, the host computer 24 provides user data (block S100). In an optional substep of the first step, the host computer 24 provides the user data by executing a host application, such as, for example, the host application 74 (block S102). In a second step, the host computer 24 initiates a transmission carrying the user data to the WD 22 (block S104), In an optional third step, the network node 16 transmits to the WD 22 the user data which was carried in the transmission that the host computer 24 initiated, in accordance with the teachings of the embodiments described throughout this disclosure (block S106). In an optional fourth step, the WD 22 executes a client application, such as, for example, the client application 114, associated with the host application 74 executed by the host computer 24 (block S108).

FIG. 11 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (block S110). In an optional substep (not shown) the host computer 24 provides the user data by executing a host application, such as, for example, the host application 74. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

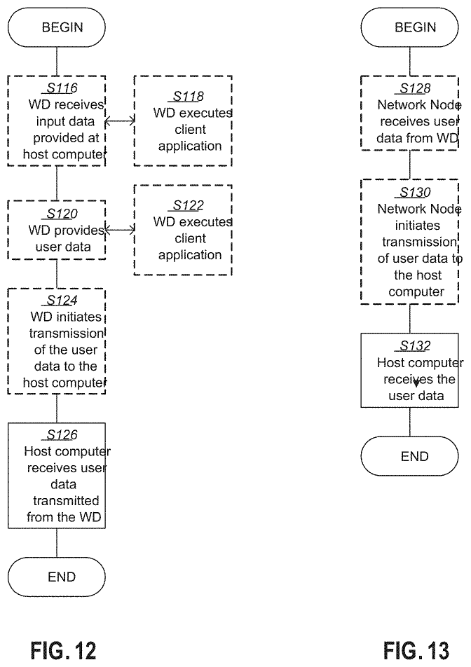

FIG. 12 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (block S116). In an optional substep of the first step, the WD 22 executes the client application 114, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 114 (block S122). In providing the user data, the executed client application 114 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 13 is a flowchart illustrating an exempla1y method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

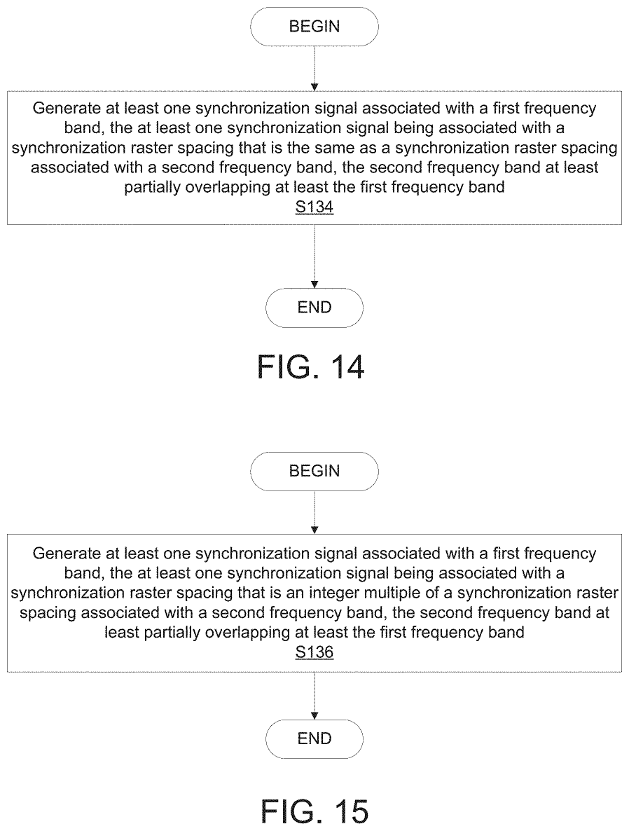

FIG. 14 is a flowchart of an exemplary process in a network node 16 for communicating synchronization signals according to one embodiment of the present disclosure. One or more blocks and/or functions and/or methods performed by the network node 16 may be performed by one or more elements of network node 16 such as by generation unit 32 in processing circuitry 68, processor 70, radio interface 62, etc. according to the example method. The example method includes generating (block S134), such as via generation unit 32, at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band.

In some embodiments of this example method, the first frequency band is different from the second frequency band. In some embodiments, in a frequency range where the first frequency band and the second frequency band overlap one another, raster entries for each of the first frequency band and the second frequency band are the same. In some embodiments, if a channel bandwidth and a subcarrier spacing corresponding to the second frequency band are the same as a channel bandwidth and a subcarrier spacing corresponding to the first frequency band, the at least one synchronization signal is based on the synchronization raster spacing that is the same as the synchronization raster spacing associated with the second frequency band. In some embodiments, the at least one synchronization signal includes at least one synchronization signal block, SS block. In some embodiments, the at least one synchronization signal includes at least one of a primary synchronization signal, PSS, and a secondary synchronization signal, SSS. In some embodiments, the method further includes communicating, such as via radio interface 62, a parameter in a system information message. The parameter indicates at least one possible frequency band associated with a raster entry of the generated at least one synchronization signal.

FIG. 15 is a flowchart of yet another exemplary process in a network node 16 for communicating synchronization signals according to another embodiment of the present disclosure. One or more blocks and/or functions and/or methods performed by the network node 16 may be performed by one or more elements of network node 16 such as by generation unit 32 in processing circuitry 68, processor 70, radio interface 62, etc. according to the example method. The example method includes generating (block S136), such as via generation unit 32, at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band.

In some embodiments of this example method, the first frequency band is different from the second frequency band. In some embodiments, if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band. In some embodiments, the at least one synchronization signal includes at least one synchronization signal block, SS block. In some embodiments, the method further includes communicating, such as via radio interface 82, a parameter in a system information message. The parameter indicates at least one possible frequency band associated with a raster entry of the generated at least one synchronization signal.

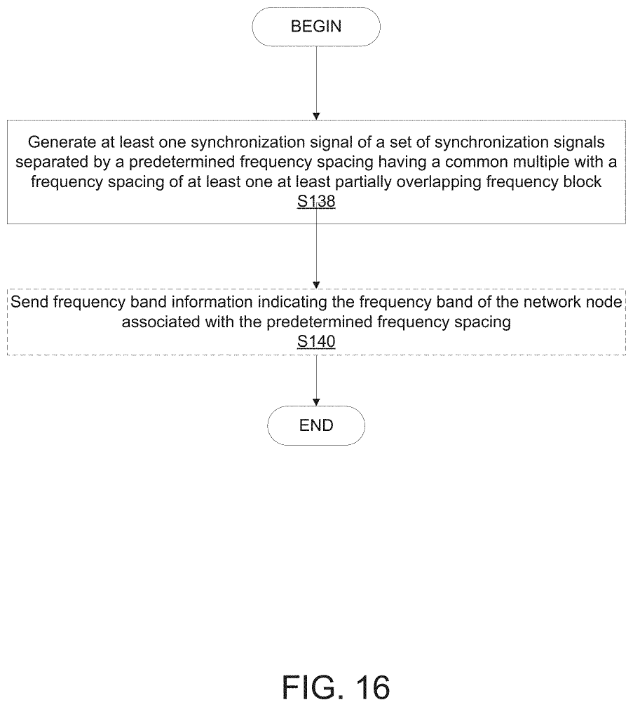

FIG. 16 is a flowchart of yet another alternative embodiment, showing an example method in a network node 16 for communicating synchronization signals to a WD 22 for, for example, cell searching according to one embodiment of the present disclosure is provided. The example process may include generating (block S138), by for example the generation unit 32, at least one synchronization signal of a set of synchronization signals. The set of synchronization signals are separated by a predetermined frequency spacing. The predetermined frequency spacing configured to have a common multiple with a frequency spacing of at least one at least partially overlapping frequency band. The process may further include optionally sending (block S140), by the band identification unit 76 for example, frequency band information in a system information message. The frequency band information indicating the at least one frequency band of the network node associated with the predetermined frequency spacing.

In yet another embodiment, an example method for a network node 16 may include generating, such as via the generation unit 32 and/or the processing circuitry 68, at least one synchronization signal associated with a first frequency band. The at least one synchronization signal is associated with a synchronization raster spacing that is a common integer multiple of a synchronization raster spacing associated with a second frequency band. The second frequency band is at least partially overlapping at least the first frequency band.

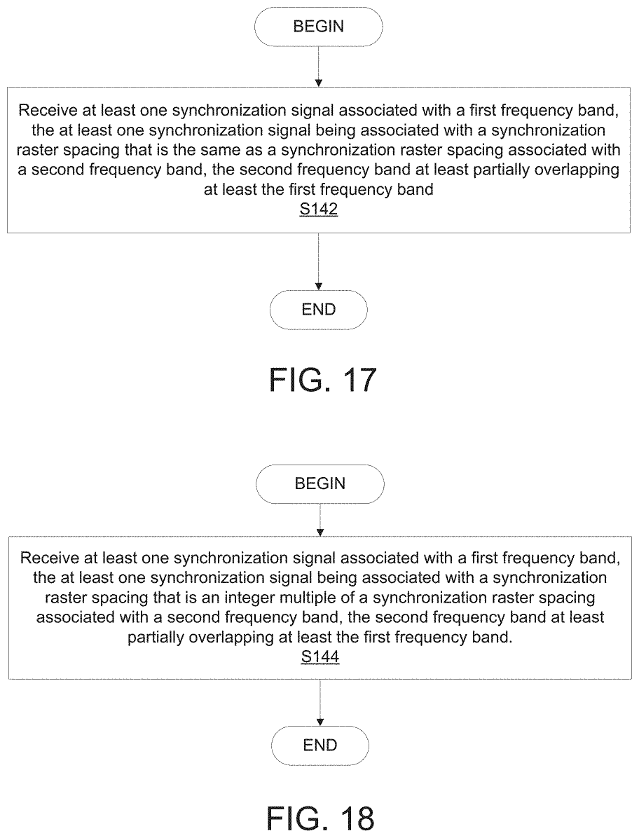

FIG. 17 is a flowchart of an exemplary process in a wireless device 22 for searching for a cell in an environment with at least partially overlapping frequency bands. One or more blocks and/or functions and/or methods performed by WD 22 may be performed by one or more elements of WD 22 such as by synchronization determination unit 34 in processing circuitry 84, processor 86, radio interface 82, etc., according to the example method. The example method may include receiving (block S142), such as via radio interface 82, at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band.

In some embodiments of the example method, the first frequency band is different from the second frequency band. In some embodiments, in a frequency range where the first frequency band and the second frequency band overlap one another, raster entries for each of the first frequency band and the second frequency band are the same. In some embodiments, if a channel bandwidth and a subcarrier spacing corresponding to the second frequency band are the same as a channel bandwidth and a subcarrier spacing corresponding to the first frequency band, the at least one synchronization signal is based on the synchronization raster spacing that is the same as the synchronization raster spacing associated with the second frequency band. In some embodiments, the at least one synchronization signal includes at least one synchronization signal block, SS block. In some embodiments, the at least one synchronization signal includes at least one of a primary synchronization signal, PSS, and a secondary synchronization signal, SSS. In some embodiments, the method further includes receiving, such as via radio interface 82, a parameter in a system information message. The parameter indicates at least one possible frequency band associated with a raster entry of the received at least one synchronization signal. In some embodiments, the method further includes performing, such as via synchronization determination unit 34, a cell search and identifying the first frequency band based at least in part on the received at least one synchronization signal.

FIG. 18 is a flowchart of vet another exemplary process in a wireless device 22 associated with synchronization signals. One or more blocks and/or functions and/or methods performed by WD 22 may be performed by one or more elements of WD 22 such as by synchronization determination unit 34 in processing circuitry 84, processor 86, radio interface 82, etc., according to the example method. The example method includes receiving (block S144), such as via radio interface 82, at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band.

In sonic embodiments of this example method, the first frequency band is different from the second frequency band. In some embodiments, if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band. In some embodiments, the at least one synchronization signal includes at least one synchronization signal block, SS block. In some embodiments, the method further includes receiving, such as via radio interface 82, a parameter in a system information message. The parameter indicates at least one possible frequency band associated with a raster entry of the received at least one synchronization signal. In some embodiments, the method includes performing, such as via synchronization determination unit 34, a cell search and identifying the first frequency band based at least in part on the received at least one synchronization signal.

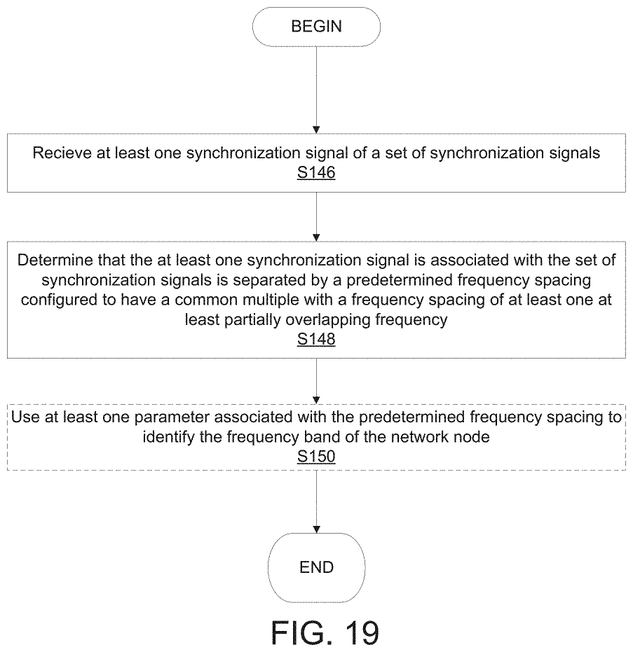

FIG. 19 is a flowchart of yet another alternative embodiment, showing an example process may include receiving (block S146), from the network node 16, at least one synchronization signal of a set of synchronization signals. The process may further include determining (block S148), by for example the synchronization determination unit 34, that the at least one synchronization signal is associated with the set of synchronization signals being separated by a predetermined frequency spacing. The predetermined frequency spacing is configured to have a common multiple with a frequency spacing of at least one at least partially overlapping frequency band. In sonic embodiments, the process may further optionally include, by for example, the band determination unit 94, after identifying a position of the at least one synchronization signal, using (block S150) at least one parameter associated with the predetermined frequency spacing to identify the at least one frequency band of the network node 16 for connecting to the network node 16.

In yet another embodiment, an example method for a WD 22 may include receiving, such as via the synchronization determination unit 34 and/or the processing circuitry 84, at least one synchronization signal associated with a first frequency band. The at least one synchronization signal is associated with a synchronization raster spacing that is a common integer multiple of a synchronization raster spacing associated with a second frequency band. The second frequency band is at least partially overlapping at least the first frequency band.

In some embodiments, a method may include a system method for a system including the network node 16 and WD 22 configured as discussed herein. In one embodiment, the method may include the network node 16 generating at least one synchronization signal associated with a first frequency band. The at least one synchronization signal is associated with a synchronization raster spacing that is the same as a synchronization raster spacing associated with a second frequency band. The second frequency band is at least partially overlapping at least the first frequency band. The wireless device 22 receives the at least one generated synchronization signal.

In another embodiment, the method for the system may include the network node 16 generating at least one synchronization signal associated with a first frequency band. The at least one synchronization signal is associated with a synchronization raster spacing that is an integer multiple of a synchronization raster spacing associated with a second frequency band. The second frequency band is at least partially overlapping at least the first frequency band. The wireless device receives the at least one generated synchronization signal.

Having generally described some techniques for configuring synchronization raster spacing in overlapping bands according to some embodiments of the present disclosure, a more detailed description of sonic of the embodiments is described below.

Embodiments of the present disclosure provide methods and apparatuses for potentially reducing cell search times and/or increasing resource efficiency. In one embodiment, if two overlapping bands have the same parameters in terms of minimum channel BW and SCS, they can also have the same SS raster spacing ΔF_{SC,Raster}. In this case, the fewest number of entries may be achieved if the two channel rasters of the two overlapping bands are also completely overlapping, or at least substantially overlapping. This means that in the frequency range where the bands are overlapping, the two bands may have exactly the same raster entries. This is achieved if the same formula is used to define the SS raster entries in the two bands. The principle applies for more than two bands as well.

As used herein, the terms “raster entries,” “raster positions,” “raster points,” “synchronization signal positions,” and the like may be used interchangeably in some embodiments, which embodiments may use the techniques discussed herein throughout for other types of synchronization signals associated with cell searching. As used herein, the term “spacing,” “raster spacing.” “sync raster spacing,” “frequency spacing” and “interval” are used interchangeably in some embodiments, and are intended to indicate a spacing or interval between adjacent raster entries.

In another embodiment, if the two bands have the same SCS for their SS blocks, but different minimum channel BW, the SS raster spacing ΔF_{SC,Raster} may be different between the bands. In this case, in some embodiments, as many as possible of the raster entries should overlap, in order to minimize the total number of raster entries. This is for example achieved if the sync raster spacings in two bands are integer multiples of each other. Optionally, in some embodiments, the set of synchronization signals in overlapping bands may be separated by a frequency spacing, which may be a predetermined frequency spacing, that is configured to have a common multiple with a frequency spacing of at least one at least partially overlapping frequency band. Stated yet another way, in some embodiments, the raster frequency spacing may be shared amongst the overlapping bands. In some embodiments, if there are more than two overlapping bands, each band may have a. sync raster spacing being integer multiples of some of, or all of the bands that have smaller ΔF_{SC,Raster}. Optionally, in some embodiments, the predetermined frequency spacing may be determined based on a maximum frequency spacing allowed by a smallest one of the at least one at least partially overlapping frequency band.

When the WD 22 has identified the position of the synchronization channel/signal, it may further identify the full RF channel. One parameter the WD 22 may need to identify is the band that the RF channel belongs to. As used herein, the terms “band” and “frequency band” are used interchangeably and are intended to indicate a frequency band. In some embodiments, if the frequency range is unique to one band, the WD 22 may determine that RF channel belongs to the one band that is unique to the frequency range. On the other hand, if the frequency range belongs to two or more overlapping bands, further steps may be required to identify the band that the RF channel belongs to. In such case, in some embodiments, if the SS raster entry is defined for only one band of the overlapping bands, the WD 22 may determine that the operating band of the network node 16 that the WD 22 is detecting is based on the raster entry position where the SS block is found.

In some embodiments, if the SS block is defined for two different SCS, and each SCS corresponds to a unique band, the WD 22 can hypothesize by attempting to read the SS block with each possible SCS. In some embodiments, if the SS block can be read by the WD 22 using one SCS, the WD 22 has also identified the band related to that SCS. Stated another way, in some embodiments, if the SS block can be read by the WD 22 using one SCS, the WD 22 may determine that the operating band of the network node 16 that the WD 22 is detecting corresponds to the SS block that the WD 22 is able to read using the one SCS.

Although some embodiments of the present disclosure may be described without specific reference to the activities specific to the network node 16 and the WD 22, it should be understood that the network node 16 transmits synchronization signals downstream to the WD 22, which receives such synchronization signals and processes them in order to establish a connection between the WD 22 and the network node 16.

In some embodiments, if the raster entry is defined for an SCS and the raster entry is used for more than one operating band having the same SCS, the raster position may in itself not reveal the band to the WD 22. In such embodiments, the band information may then be present in a system information message on the PBCH or in other system information that is read by the WD 22 at a later stage. Because the number of possible bands on a raster entry is limited and could be, for example, 4 different bands, the band information can be encoded efficiently by using, for example, 2 bits of information. In some embodiments, the full band information in NR is 9 bits.

There are advantages of embodiments of the present disclosure. Some of these advantages are described below. For example, fewer sync raster entries means that the WD 22 will have fewer possible entries to search during initial access. Reducing the time for initial access can be important for efficient operation and a good experience for the end user. This may be done by keeping the number of SS raster entries that the WD 22 has to search at a minimum. The present disclosure provides for methods and apparatuses that minimize the number of SS raster entries in cases where bands overlap, instead of each band having its own independent set of raster entries.

In some embodiments, identifying the band of an RF carrier that is found through the SSS/PSS and PBCH on the SS block at an early stage may also reduce cell search time for the WD 22, since the WD 22 at an early stage can decide whether the RF carrier received is worth pursuing to set up a connection with the transmitting/broadcasting network node 16. By being able to derive the band from the SS raster position or an SCS corresponding to a unique band, this early decision can be made by the WD 22, in case bands are overlapping.

In some embodiments, if further information needs to be read/received by the WD 22 to make the decision about the band associated with the synchronization channel, having as few bits as possible is also efficient, since the number of system information bits available is limited, in particular for system information that is broadcasted by the network node 16. By having a parameter pointing only at the different bands possible for that raster position, the number of band options can be kept at a minimum.

The example in Table 1 and FIG. 4, described herein above, illustrates three different parameter sets and the SS raster entries that may result. The example uses 10, 15 and 20 MHz minimum channel bandwidth and 15 kHz SCS, which results in the maximum possible SS raster spacing (ΔF_{SS,Raster} ) shown in the Table 1 and FIG. 4.

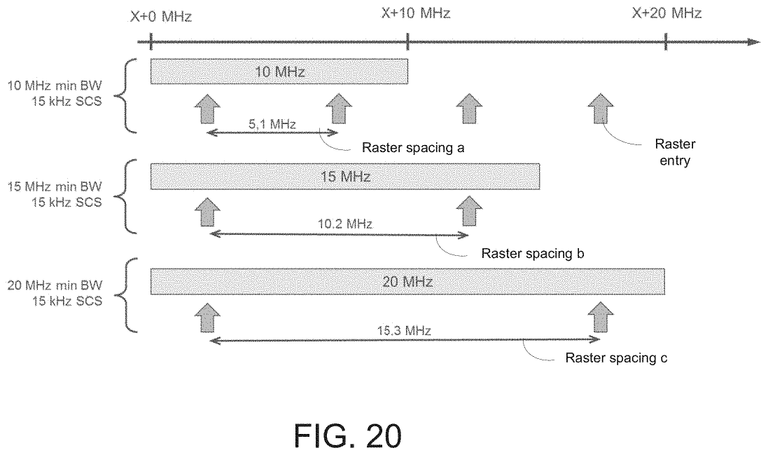

In other embodiments, it is however possible to make a different choice of ΔF_{SS,Raster} according to embodiments of the present disclosure that may provide advantages for the initial access of the WD 22 to the network node 16. For example, in some embodiments, the SS raster spacings/intervals (e.g., raster spacing a, b, and c) are integer multiples of each other as far as possible (e.g., 5.1 MHz * n). An example of such feature is demonstrated in FIG. 20, where 5.1, 10.2 and 15.3 MHz are chosen for the 10, 15 and 20 MHz min channel BW, respectively. The chosen numbers (SS raster spacings) are within the limits defined in equation (1), but relate to each other as the integers 1:2:3. In other words, in some embodiments, the sync raster spacing in overlapping bands may be configured to be integer multiples of each other. Stated another way, in some embodiments, the sync raster spacing in overlapping bands may be configured with a common multiple (e.g., 5.1 MHz). In some embodiments, each band may be configured to have its own SS raster according to, for example, FIG. 20, using a total of only, for example, 4 raster points in the 20 MHz range, even if bands are overlapping.

This means that in some embodiments in, for example, the 20 MHz range shown in FIG. 20:
for at least two overlapping bands having 15 kHz SCS with one of the overlapping bands having 10 MHz minimum channel BW and another of the overlapping band having a 15 MHz minimum channel BW, a total of 4 raster entries may be needed instead of 4+2=6 entries.
for at least two overlapping bands having 15 kHz SCS with one of the overlapping bands having 10 MHz minimum channel BW and another of the overlapping bands having a 20 MHz minimum channel BW, a total of 4 raster entries may be needed instead of 4+2=6 entries.
for at least three overlapping bands having 15 kHz SCS, and having 10, 15 and 20 MHz minimum channel Ms respectively, a total of 4 raster entries may be needed instead of 4+2+2=8 entries.

Some additional embodiments may include one or more of the following:

Embodiment A1. A network node configured to communicate with a wireless device (WD), the network node comprising a radio interface and processing circuitry, the processing circuitry configured to cause the radio interface to generate at least one synchronization signal of a set of synchronization signals, the set of synchronization signals being separated by a predetermined frequency spacing, the predetermined frequency spacing configured to have a common multiple with a frequency spacing of at least one at least partially overlapping frequency band.

Embodiment A2. The network node according to Embodiment A1, wherein the predetermined frequency spacing is determined based on a maximum frequency spacing allowed by a smallest one of the at least one at least partially overlapping frequency band.

Embodiment A3. The network node according to any of Embodiments A1 and A2, wherein the predetermined frequency spacing is a sync raster spacing of the network node and the at least one synchronization signal includes at least one of a primary synchronization signal (PSS) and a secondary synchronization signal (SSS).

Embodiment A4. The network node according to any of Embodiments A1-A3, wherein the processing circuitry is further configured to cause the radio interface to send frequency band information in a system information message, the frequency band information indicating the at least one frequency band of the network node associated with the predetermined frequency spacing.

Embodiment B1. A communication system including a host computer, the host computer comprising:
processing circuitry configured to provide user data; and
a communication interface configured to forward the user data to a cellular network for transmission to a wireless device (WD),
the cellular network comprising a network node having a radio interface and processing circuitry, the network node's processing circuitry configured to cause the radio interface to generate at least one synchronization signal of a set of synchronization signals, the set of synchronization signals being separated by a predetermined frequency spacing, the predetermined frequency spacing configured to have a common multiple with a frequency spacing of at least one at least partially overlapping frequency band.

Embodiment B2. The communication system of Embodiment B1, further including the network node.

Embodiment B3. The communication system of Embodiment B2, further including the WD, wherein the WD is configured to communicate with the network node.

Embodiment B4. The communication system of Embodiment B3, wherein:

the processing circuitry of the host computer is configured to execute a host application, thereby providing the user data; and

the WD comprises processing circuitry configured to execute a client application associated with the host application.

Embodiment C1. A method implemented in a network node, the method comprising generating at least one synchronization signal of a set of synchronization signals, the set of synchronization signals being separated by a predetermined frequency spacing, the predetermined frequency spacing configured to have a common multiple with a frequency spacing of at least one at least partially overlapping frequency band.

Embodiment C2. The method according to Embodiment C1, wherein the predetermined frequency spacing is determined based on a maximum frequency spacing allowed by a smallest one of the at least one at least partially overlapping frequency band,

Embodiment C3. The method according to any of Embodiments C1 and C2, wherein the predetermined frequency spacing is a sync raster spacing of the network node and the at least one synchronization signal includes at least one of a primary synchronization signal (PSS) and a secondary synchronization signal (SSS).

Embodiment C4. The method according to any of Embodiments C1-C3, further comprising sending frequency band information in a system information message, the frequency band information indicating the at least one frequency band of the network node associated with the predetermined frequency spacing.

Embodiment D1. A method implemented in a communication system including a host computer, a network node and a wireless device (WD), the method comprising:

at the host computer, providing user data; and

at the host computer, initiating a transmission carrying the user data to the WD via a cellular network comprising the network node, the network node generating at least one synchronization signal of a set of synchronization signals, the set of synchronization signals being separated by a predetermined frequency spacing, the predetermined frequency spacing configured to have a common multiple with a frequency spacing of at least one at least partially overlapping frequency band.

Embodiment D2. The method of Embodiment D1, further comprising, at the network node, transmitting the user data.

Embodiment D3. The method of Embodiment D2, wherein the user data is provided at the host computer by executing a host application, the method further comprising, at the WD, executing a client application associated with the host application.

Embodiment E1. A wireless device (WD) configured to communicate with a network node, the WD comprising a radio interface and processing circuitry, the processing circuitry configured to:

cause the radio interface to receive, from the network node, at least one synchronization signal of a set of synchronization signals; and

determine that the at least one synchronization signal is associated with the set of synchronization signals being separated by a predetermined frequency spacing, the predetermined frequency spacing configured to have a common multiple with a frequency spacing of at least one at least partially overlapping frequency band.

Embodiment E2. The wireless device according to Embodiment E1, wherein the predetermined frequency spacing is determined based on a maximum frequency spacing allowed by a smallest one of the at least one at least partially overlapping frequency band.

Embodiment E3. The wireless device according to any of Embodiments E1 and E2, wherein the predetermined frequency spacing is a sync raster spacing of the network node and the at least one synchronization signal includes at least one of a primary synchronization signal (PSS) and a secondary synchronization signal (SSS).

Embodiment E4. The wireless device according to any of Embodiments E1-E3, wherein the processing circuitry is further configured to cause the radio interface to receive frequency band information in a system information message, the frequency band information indicating the at least one frequency band of the network node associated with the predetermined frequency spacing.

Embodiment E5. The wireless device according to any of Embodiments E1-E4, wherein the processing circuitry is further configured to, after identifying a position of the at least one synchronization signal, using at least one parameter associated with the predetermined frequency spacing to identify the at least one frequency band of the network node for connecting to the network node.

Embodiment F1. A communication system including a host computer, the host computer comprising:

processing circuitry configured to provide user data.; and

a communication interface configured to forward user data to a cellular network for transmission to a wireless device (WD),
the WD comprising a radio interface and processing circuitry, the WD's processing circuitry configured to:
   cause the radio interface to receive at least one synchronization signal of a set of synchronization signals; and
   determine that the at least one synchronization signal is associated with the set of synchronization signals being separated by a predetermined frequency spacing, the predetermined frequency spacing configured to have a common multiple with a frequency spacing of at least one at least partially overlapping frequency band.

Embodiment F2. The communication system of Embodiment F1, further including the WD.

Embodiment F3. The communication system of Embodiment F2, wherein the cellular network further includes a network node configured to communicate with the WD.

Embodiment F4. The communication system of Embodiment F2 or F3, wherein:

the processing circuitry of the host computer is configured to execute a host application, thereby providing the user data; and

the WD's processing circuitry is configured to execute a client application associated with the host application.

Embodiment G1. A method implemented in a wireless device (WD), the method comprising:

receiving, from a network node, at least one synchronization signal of a set of synchronization signals; and

determining that the at least one synchronization signal is associated with the set of synchronization signals being separated by a predetermined frequency spacing, the predetermined frequency spacing configured to have a common multiple with a frequency spacing of at least one at least partially overlapping frequency band.

Embodiment G2. The method according to Embodiment G1, wherein the predetermined frequency spacing is determined based on a maximum frequency spacing allowed by a smallest one of the at least one at least partially overlapping frequency band.

Embodiment G3. The method according to any of Embodiments G1 and G2, wherein the predetermined frequency spacing is a sync raster spacing of the network node and the at least one synchronization signal includes at least one of a primary synchronization signal (PSS) and a secondary synchronization signal (SSS).

Embodiment G4. The method according to any of Embodiments G1-G3, further comprising receiving frequency band information in a system information message, the frequency band information indicating the at least one frequency band of the network node associated with the predetermined frequency spacing.

Embodiment G5. The method according to any of Embodiments G1-G4, further comprising; after identifying a position of the at least one synchronization signal, using at least one parameter associated with the predetermined frequency spacing to identify the at least one frequency band of the network node for connecting to the network node.

Embodiment H1. A method implemented in a communication system including a host computer, a network node and a wireless device (WD), the method comprising:

at the host computer, providing user data; and

at the host computer, initiating a transmission carrying the user data to the WD via a cellular network comprising the network node;

the WD:
receiving, from the network node, at least one synchronization signal of a set of synchronization signals; and
determining that the at least one synchronization signal is associated with the set of synchronization signals being separated by a predetermined frequency spacing, the predetermined frequency spacing configured to have a common multiple with a frequency spacing of at least one at least partially overlapping frequency band.

Embodiment H2. The method according to Embodiment H1, further comprising, at the WD, receiving the user data from the network node.

Embodiment I1. A network node, comprising:

a memory module configured to store a predetermined frequency spacing configured to have a common multiple with a frequency spacing of at least one at least partially overlapping frequency band; and

a generation module configured to generate at least one synchronization signal of a set of synchronization signals, the set of synchronization signals being separated by the predetermined frequency spacing.

Embodiment I2, A wireless device, comprising:

a memory module configured to store a predetermined frequency spacing configured to have a common multiple with a frequency spacing of at least one at least partially overlapping frequency band; and

a synchronization determination module configured to receive at least one synchronization signal of a set of synchronization signals and determine that the at least one synchronization signal is associated with the set of synchronization signals being separated by the predetermined frequency spacing.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area. network (LAN) or a wide area. network (WAN), or the connection may be made to an external computer (for example, through the Internet using an Internet Service Provider).

Many different embodiments have been disclosed herein; in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to What has been particularly shown and described herein above. In addition, unless mention was made above to the contrary, it should be noted that all of the accompanying drawings are not to scale, A variety of modifications and variations are possible in light of the above teachings, without departing from the scope of the following claims.

1.-30. (canceled)

31. A network node configured to communicate with a wireless device, WD, the network node comprising a radio interface and processing circuitry, the processing circuitry configured to cause the radio interface to:
generate at least one synchronization signal associated with a first frequency band, the at least one synchronization signal being associated with a synchronization raster spacing that is an integer multiple of a synchronization raster spacing associated with a second frequency band, the second frequency band at least partially overlapping at least the first frequency band.

32. The network node of claim 31, wherein the first frequency band is different from the second frequency band.

33. The network node of claim 31, wherein if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band.

34. The network node of claim 31, wherein the at least one synchronization signal includes at least one synchronization signal block, SS block.

35. The network node of claim 33, wherein the processing circuitry is further configured to cause the radio interface to communicate a parameter in a system information message, the parameter indicating at least one possible frequency band associated with a raster entry of the generated at least one synchronization signal.

36. A method for a network node configured to communicate with a wireless device, WD, the method comprising:
generating at least one synchronization signal associated with a first frequency band, the at least one synchronization signal being associated with a synchronization raster spacing that is an integer multiple of a synchronization raster spacing associated with a second frequency band, the second frequency band at least partially overlapping at least the first frequency band.

37. The method of claim 36, wherein the first frequency band is different from the second frequency band.

38. The method of claim 36, wherein if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band.

39. The method of claim 36, wherein the at least one synchronization signal includes at least one synchronization signal block, SS block.

40. The method of claim 36, further comprising communicating a parameter in a system information message, the parameter indicating at least one possible frequency band associated with a raster entry of the generated at least one synchronization signal.

41. A wireless device, WD, configured to communicate with a network node, the WD comprising a radio interface and processing circuitry, the processing circuitry configured to:
receive at least one synchronization signal associated with a first frequency band, the at least one synchronization signal being associated with a synchronization raster spacing that is an integer multiple of a synchronization raster spacing associated with a second frequency band, the second frequency band at least partially overlapping at least the first frequency band.

42. The WD of claim 41, wherein the first frequency band is different from the second frequency band.

43. The WD of claim 41, wherein if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band.

44. The WD of claim 41, wherein the at least one synchronization signal includes at least one synchronization signal block, SS block.

45. The WD of claim 41, wherein the radio interface is configured to receive a parameter in a system information message, the parameter indicating at least one possible frequency band associated with a raster entry of the received at least one synchronization signal.

46. The WD of claim 41, wherein the processing circuitry is further configured to perform a cell search and identify the first frequency band based at least in part on the received at least one synchronization signal.

47. A method for a wireless device, WD, configured to communicate with a network node, the method comprising:
receiving at least one synchronization signal associated with a first frequency band, the at least one synchronization signal being associated with a synchronization raster spacing that is an integer multiple of a synchronization raster spacing associated with a second frequency band, the second frequency band at least partially overlapping at least the first frequency band.

48. The method of claim 47, wherein the first frequency band is different from the second frequency band.

49. The method of claim 47, wherein if a channel bandwidth corresponding to the second frequency band is different from a channel bandwidth corresponding to the first frequency band, the at least one synchronization signal is based on the synchronization raster spacing that is the integer multiple of the synchronization raster spacing associated with the second frequency band.

50. The method of claim 47, wherein the at least one synchronization signal includes at least one synchronization signal block, SS block.

51. The method of claim 47, further comprising receiving a parameter in a system information message, the parameter indicating at least one possible frequency band associated with a raster entry of the received at least one synchronization signal.

52. The method of claim 47, further comprising performing a cell search and identifying the first frequency band based at least in part on the received at least one synchronization signal.

53.-57. (canceled)

58. The network node of claim 31, wherein the integer multiple is greater than 1.

59. The method of claim 36, wherein the integer multiple is greater than 1.

60. The wireless device of claim 41, wherein the integer multiple is greater than 1.

61. The method of claim 47, wherein the integer multiple is greater than 1.
